(19) United States
(12) Patent Application Publication
(10) Pub. No.: US 2006/0093694 A1
(43) Pub. Date: May 4, 2006

(54) Electro-mechanical injection actuator for controllably rotating and translating the feedscrew of a single-stage injection molding machine

(75) Inventor: Dan R. Malwitz, Orchard Park, NY (US)

Correspondence Address: PHILLIPS LYTLE LLP;INTELLECTUAL PROPERTY GROUP, 3400 HSBC CENTER, BUFFALO, NY, 14203-3509, US

(73) Assignee: Moog Inc.

(21) Appl. No.: 10/980,462

(22) Filed: Nov. 3, 2004

(51) Int. Cl. B29C 45/54

(52) U.S. Cl. 425/145; 425/587

(57) ABSTRACT

An electromechanical injection actuator (20) as arranged to controllably rotate and translate a feedscrew relative to a frame (28) to express plastic material into a mold. The improved actuator includes a ball-screw (24) mounted on the frame, the ball-screw having a nut (26) matingly engaging a screw (25), the screw being attached to the feedscrew (F); an electric metering motor (21) mounted on the frame and having a rotatable output shaft (22), the rotational movement of the output shaft being transmitted to the screw through a splined connection (40, 41); an injection motor (45) mounted on the frame and operatively arranged to selectively rotate the nut relative to the frame; and a unidirectional clutch or brake (29) operatively arranged between the nut and frame for permitting the nut to rotate relative to the frame only in the angular direction needed to translate the feedscrew in a direction to express plastic material into the mold. The clutch/brake prevents the nut from being moved in the opposite angular direction under the influence of pressurized plastic material in the mold.

### TECHNICAL FIELD

The present invention relates generally to actuators for holding a rotatable member against the reactionary force exerted by a compressed elastic load, and, more particularly, to an improved electromechanical injection actuator for controllably rotating and translating the feedscrew of a single-stage injection molding machine to express heated plastic material into, and to hold hot pressurized plastic material in, a mold.

### BACKGROUND ART

A single-stage injection molding machine, sometimes known as a reciprocating screw injection molding machine, typically has a feedscrew operatively arranged in a cylindrical barrel. The barrel is surrounded by a plurality of heater bands. A hopper is operatively arranged to feed pelletized material to the heated barrel. The screw is rotated relative to the barrel. Hence, granular or pelletized plastic material is heated and is advanced along the rotating screw to accumulate or pool at the forward end thereof. At the same time, the screw may be withdrawn (i.e., translated rearwardly relative to the frame) to allow the heated plastic material to pool in sufficient quantity ahead of the screw. Thereafter, when it is desired to inject the heated plastic material into a mold, the feedscrew is translated forwardly by means of an injection ram toward the mold to express the plastic material into the mold. It is often desired to hold the pressurized hot plastic material in the mold as the material begins to cool.

However, the hot plasticized material in the mold is elastic and is under compression, and exerts a reactionary or bounce-back force on the feedscrew that urges the feedscrew to move away from the mold.

In recent years, there has been a tendency to favor electromechanical actuators that eliminate hydraulics and hydraulic fluid. In such electromechanical actuators, two electric motors are commonly used. A metering motor is operatively arranged to selectively rotate the feedscrew. An injection motor is used to physically translate the feedscrew within the heated barrel, either in connection with or independently of the rotation of the feedscrew. This type of arrangement is known, and is representatively shown and described in U.S. Pat. Nos. 5,679,384, 5,891,485 and 6,659,723, the aggregate disclosures of which are hereby incorporated by reference.

Such electromechanical injection actuators that have been heretofore developed utilize a ball-screw. Basically, this arrangement has a screw mounted for movement relative to a nut while a plurality of balls recirculated through an endless path defined in the nut. A metering motor may be operatively arranged to rotate the screw, and an injection motor may be operatively arranged to translate the screw.

However, one problem that has been encountered lies in the ability of such apparatus to resist the bounce-back or reactionary force exerted on the ball-screw by the plastic that is compressed in the mold. This load is elastic, and has a springy effect that exerts a reactionary force on the ball-screw.

It would be desirable to design an electromechanical injection actuator having an injection motor optimally sized so as to be capable of injecting heated plastic material into the mold. However, such device must also be prepared to hold the hot plastic material in the mold against the reactionary force exerted by the plastic material on the ball-screw. In some cases, it is believed that an optimally-sized injection motor may be insufficient to resist the reactionary torque exerted by the compressed load on the ball-screw, particularly after the injecting motion of the feedscrew has stopped. At the same time, it would be desirable to have an optimally-sized injection motor to keep the cost of the apparatus at a practical minimum. Accordingly, some other means of resisting the bounce-back or reactionary force exerted by the compressed plastic on the ball-screw must be found.

### DISCLOSURE OF THE INVENTION

With parenthetical reference to the corresponding parts, portions and surfaces of the disclosed embodiment, merely for purposes of illustration and not by way of limitation, the present invention broadly provides an improved actuator, and, more particularly, provides an improved electromechanical injection actuator for controllably rotating and translating the feedscrew of a single-stage injection molding machine.

In one aspect, the invention provides an improved actuator (20) for holding a rotatable member (26) against the reactionary force exerted by a compressed elastic load, such as a charge of hot compressed plastic in a confined mold cavity. The improved actuator broadly includes: a frame (28); a motor (45) mounted on the frame and operatively arranged to selectively rotate the member (26) in one angular direction relative to the frame to move a surface (49) toward or away from the load by rotating nut (26) either faster or slower, respectively, than the screw (25); and a unidirectional clutch (29) acting between the member and frame for permitting the member to rotate in the one angular direction and for preventing the member from rotating in the opposite angular direction; whereby the motor may be selectively operated to move the surface to engage the load, and the clutch will prevent the member from unintentionally rotating in the opposite direction under the influence of the load.

In the presently-preferred embodiment, the actuator includes a ball-screw (24) having a screw (25) and a nut (26), both independently rotatable relative to the frame. The actuator may be used to drive the feedscrew (F) of a single-stage injection molding machine. The motor may be an injection motor (45) for translating the surface toward and away from the load. The motor may be a brushless d.c. motor. The actuator may further include a metering motor (21) operatively arranged to selectively rotate the screw (25) of the ball-screw relative to the frame. A gear train (23) may be operatively arranged between the metering motor and the screw. A splined connection (40, 41) may be arranged between the gear train and the screw.

In another aspect the invention provides an improved actuator (20) for holding a rotatable member (26) against the reactionary force exerted by a compressed elastic load. The improved actuator broadly includes: a frame (28); a motor (45) mounted on the frame and operatively arranged to selectively rotate the member in one angular direction to move a surface toward and away from the load; and a unidirectional brake (29) acting between the member and frame for permitting the member to rotate in one angular direction and for preventing the member from rotating in the opposite angular direction relative to the frame; whereby the motor may be selectively operated to move the surface to engage the load, and the clutch will prevent the member from unintentionally rotating in the opposite direction relative to the frame under the influence of the load.

In another aspect, the invention provides an electro-mechanical injection actuator (20) for controllably rotating and translating a feedscrew (F) relative to a frame (28) to express hot plastic material into a mold. The feedscrew is rotated and retracted during plasticizing at the rate required to move the appropriate amount of plastic to the mold end of the feedscrew. Retraction is accomplished by rotating the nut (26) somewhat more slowly than the screw (25). The plastic pressure is maintained at this time by varying the torque of the injection motor (45). The improved actuator broadly comprises: a ball-screw (24) mounted on the frame, the ball-screw having a nut (26) matingly engaging a screw (25), the screw being attached to the feedscrew (F); an electric metering motor (21) mounted on the frame and having a rotatable output shaft (22), the rotational movement of the output shaft being transmitted to the screw through a splined connection (40, 41); an electric injection motor (45) mounted on the frame and operatively arranged to selectively rotate the nut relative to the frame so as to translate the screw relative to the frame; and a unidirectional clutch (29) operatively arranged between the nut and frame for permitting the nut (26) to rotate relative to the frame only in the angular direction needed to translate the feedscrew in a direction to express plastic material into the mold; whereby the clutch will prevent the nut from being moved in the opposite angular direction under the influence of the pressurized plastic material in the mold.

The injection motor (45) may be a d.c. brushless motor. A speed reducer (23) may be arranged between the output shaft and the screw. The speed reducer may be a gear train having a speed reduction ratio of about 9:1.

In still another aspect, the invention provides an electro-mechanical injection actuator (20) for controllably rotating and translating a feedscrew (F) relative to a frame to express plastic material into a mold. The improved actuator broadly includes: a ball-screw (24) mounted on the frame, the ball-screw having a nut (26) matingly engaging a screw (25), the screw being attached to the feedscrew; an electric metering motor (21) mounted on the frame and having a rotatable output shaft (22), the rotational movement of the output shaft being transmitted to the screw through a splined connection (40, 41); an electric injection motor (45) mounted on the frame and operatively arranged to selectively rotate the nut relative to the frame; and a unidirectional brake (29) operatively arranged between the nut and frame for permitting the nut to rotate relative to the frame only in the angular direction needed to translate the feedscrew in a direction to express plastic material into the mold; whereby the clutch will prevent the nut from being moved in the opposite angular direction under the influence of the pressurized plastic material in the mold.

The injection motor may be a d.c. brushless motor. A speed reducer (23) may be arranged between the output shaft and the screw. The speed reducer may have a gear train having a speed reduction ratio of about 9:1.

Accordingly, the general object of the invention is to provide an improved actuator.

Another object is to provide an improved actuator for holding a rotatable member against the reactionary force exerted by a compressed elastic load.

Still another object is to provide an improved electromechanical injection actuator for controllably rotating and translating the feedscrew of a single-stage injection molding machine relative to a frame to express heated plastic material into, and to hold hot plastic material in, a mold.

These and other objects and advantages will become apparent from the foregoing and ongoing written specification, the drawings, and the appended claims.

### BRIEF DESCRIPTION OF THE DRAWINGS

FIG. 1 is a fragmentary longitudinal view, partly in elevation and partly in section, of an improved electro-mechanical injection actuator, this view showing the two motors, the gear train, and the ball-screw.

FIG. 2 is a plot of screw rotational speed (ordinate) vs. time (abscissa).

FIG. 3 is a plot of ram speed (ordinate) vs. time (abscissa).

FIG. 4 is a plot of pressure (ordinate) vs. time (abscissa).

FIG. 5 is a plot of nut rotational speed (ordinate) vs. time (abscissa).

FIG. 6 is a plot of ram position (ordinate) vs. time (abscissa).

FIG. 7 is a plot of screw force (ordinate) vs. time (abscissa).

FIG. 8 is a plot of screw current (ordinate) vs. time (abscissa).

FIG. 9 is a plot of nut current (ordinate) vs. time (abscissa).

FIG. 10 is a plot of screw torque (ordinate) vs. time (abscissa).

FIG. 11 is a plot of nut torque (ordinate) vs. time (abscissa).

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

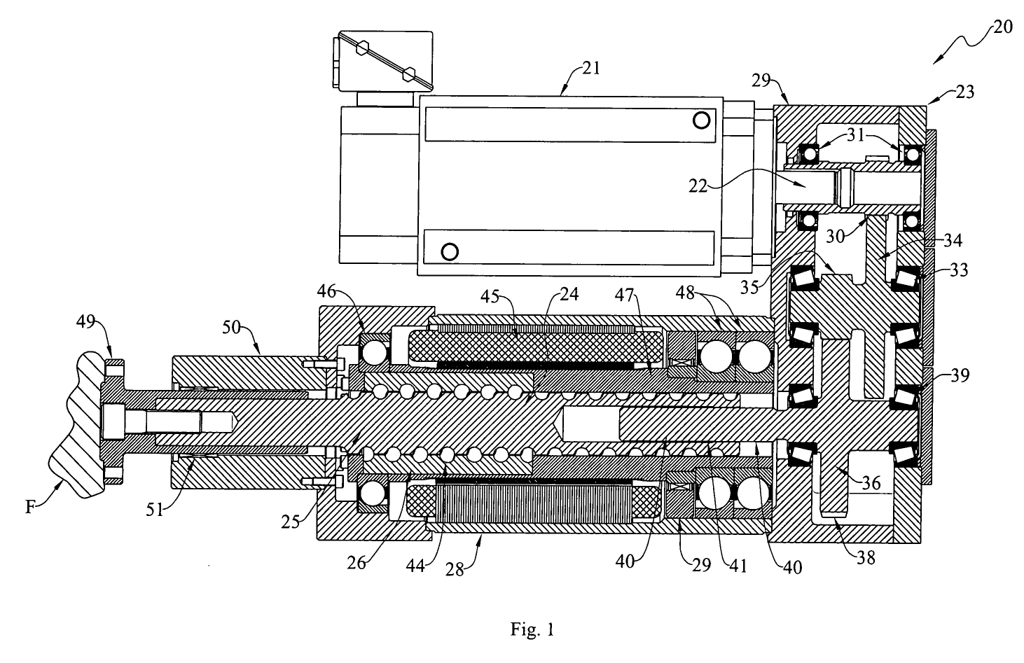

Referring now to the drawings, and, more particularly, to FIG. 1 thereof, an improved electromechanical injection actuator is generally indicated at 20. Actuator 20 is shown as broadly including a metering motor 21 having a rotatable output shaft 22; a gear train, generally indicated at 23; a ball-screw generally indicated at 24, and, more particularly, shown as including screw 25 and a nut 26; a frame 28, and a unidirectional clutch or brake 29 arranged to act between the nut 26 and the frame 28.

The metering motor 21 is shown in elevation as being an electrical motor having a rotatable output shaft 22. The gear train 23 is shown as including three gears operatively arranged within an outer housing 29. An upper gear 30 is operatively mounted on output shaft 22, and is journal for rotation in two horizontally-spaced bearings 31, 31. The middle gear 32 is journalled in horizontally-spaced bearings 33, 33, and includes a toothed portion 34 in meshing engagement with toothed portion 30. This gear also has another toothed portion 35. The lower gear 36 has a toothed portion 38 in meshing engagement with toothed portion 35, and is journalled in the gear housing by bearings 39, 39. The male portion 40 of a spline extends leftwardly from gear 36, and is received in the female splined receptacle 41 within screw 25.

Screw 25 is shown as having an outer surface that includes a plurality of ball races, severally indicated at 43. The screw penetrates the nut, and a plurality of recirculating balls, severally indicated at 44, are provided in an endless track within the nut. A d.c. brushless motor, generally indicated at 45, is operatively arranged between the frame 28 and the nut 26. This d.c. brushless motor is journalled on the frame by means of bearings 46,48. Injection motor 45 may be operated to rotate nut 26 relative to the frame via intermediate member 47.

An adapter, generally indicated at 49, is operatively mounted on the left marginal end portion of the nut, and is journalled in a frame extension 50 on a bearing 51. The left marginal end portion of adaptor 49 is adapted to be connected to the feedscrew F of a single-stage injection molding machine.

Metering motor 21 may be selectively operated to cause the screw 25 to rotate relative to the frame. More particularly, when motor 21 is operated, output shaft 22 rotates. This rotational motion is transmitted through the gear train 23, which has a gear reduction ratio of about 9:1, to the male portion 40 of the splined connection with the screw. Thus, screw 25 will rotate at about 1/9th of the rotational speed of metering motor output shaft 22. If the injection motor 45 is not rotated, such rotational movement of the screw will cause the adaptor 49 to move rotationally and leftwardly relative to the still-stationary nut. However, if the d.c. brushless motor is caused to rotate in the same direction and at the same speed as the screw, then both the screw and the nut will rotate together, and there will be no net leftward motion of adapter 49 relative to the frame. The injection motor and the metering motor may be operated independently of one another. If the metering motor is not operated, but the injection motor is operated, then the nut will rotate about the non-rotating screw, and the screw will be translated leftwardly relative to the frame.

The unidirectional clutch or brake 29 is operatively arranged to permit such rotational movement of the nut 26 and member 47 in one angular direction relative to the frame. However, clutch/brake 29 is operatively arranged to oppose and resist motion in the opposite angular direction. This clutch or brake may be, for example, a sprag-type freewheeling clutch or brake, and is available from Paul Müller Industrie GmbH & Co. KG, Äuβere Bayreuther Straβe 230, D-90411 Nürmberg, Germany. These freewheeling clutches are unidirectional couplings that are operative to transmit or support torque in one direction by friction, and to allow idling (i.e., free rotation) in the opposite direction. Thus, when the brushless motor rotates the nut in the permitted direction, clutch 29 permits such rotation of the nut relative to the frame. One angular direction is the direction of rotation that will advance the feedscrew, which is normally attached to adaptor 49, leftwardly toward the mold (not shown).

However, during the injection step, hot plastic is expressed from the volume ahead of the feedscrew into the mold. Such motion normally occurs very quickly, and also relies on the inertia of the feedscrew and plastic. However, after the mold is filled, the compressed plastic, which is somewhat springy and elastic, and the elastic compression of the feedscrew, ball-screw and other mechanical components, exert a rightward reactionary (i.e., bounce-back) force on the feedscrew. This is transmitted to the screw 25, and can back-drive the nut in the opposite direction if the injection motor is unable to withstand it. Thus, such back-driving or reversed rotation of the nut relative to the frame is effectively prevented by unidirectional clutch 29. In other words, the reactionary force exerted by the plastic on the nut, is transmitted from nut 26 through clutch 29 to the frame 28, and does not have to be resisted by the d.c. brushless motor at all. In fact, if it is desired to hold the plastic slug in the mold in a compressed condition, after injection, the injection motor may be de-energized, with the reactionary load being resisted by the unidirectional clutch. Simply preventing the feedscrew from back-driving may not be sufficient to maintain mold pressure, perhaps due to leakage. The feedscrew may have to be advanced slightly during the hold time. This can be accomplished by the screw being advanced by the metering motor with the nut be held by the unidirectional clutch.

Thus, the clutch or brake 29 has somewhat of a ratchet-like action which will permit rotation in one angular direction, but will oppose relative rotation in the opposite angular direction. In the disclosed embodiment, nut 26 and intermediate member 47 are arranged to rotate in only one angular direction, and are precluded from rotating in the opposite angular direction. As indicated previously, the metering and injection motors may be operated independently of one another to selectively control the operation of the single-staged feedscrew.

Operation

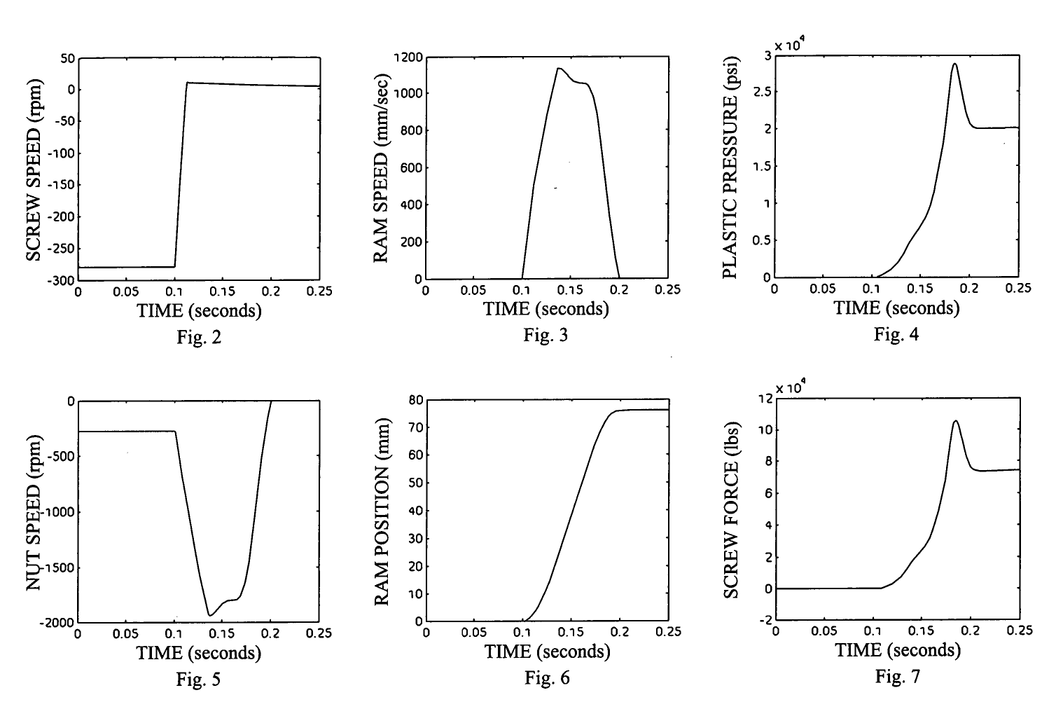

FIGS. 2-11 illustrate various operating conditions and parameters of the improved device.

FIG. 2 illustrates the rotational speed of screw 25 as a function of time. This figure particularly illustrates that screw 25 is rotating in one direction at a speed of about 280 rpm, and then quickly stops in about 1/100th of a second.

FIG. 5 shows the rotational speed of nut as a function of time. Here again, the nut is shown as rotating in the same direction of the screw at the same angular speed (i.e., about 280 rpm). However, as the screw is stopped, the nut is quickly accelerated to a speed of about 1900 rpm during the injection step.

FIG. 3 is a plot showing the ram speed (i.e., speed of injection) as a function of time. When the screw is stopped and the nut is quickly accelerated, at 0.1 seconds, it will be noted that the ram is quickly translated to a speed of about 1100 mm/sec.

FIG. 6 is a plot of ram position vs. time, and may be either physically observed, or may be derived by integrating the cure shown in FIG. 3 since speed is the time derivative of position.

FIG. 4 is a plot showing the pressure of the extruded plastic as a function of time. It should be noted that the pressure begins to build following t=0.1 seconds to a peak of about 2.6×10⁴ psi at about t=0.18 seconds, followed by a holding step at about 1.9×10⁴ psi at about t=0.2 seconds and thereafter.

FIG. 7 is a plot showing the screw force as a function of time. It should be noted that the screw force is substantially zero until the injection step starts at t=0.1 seconds. Thereafter, the screw force quickly build as the nut is accelerated to a peak of almost 10×10⁴ lbs. Thereafter, at t=0.2 seconds, the screw force is held at about 7×10⁴ lbs. in the mold.

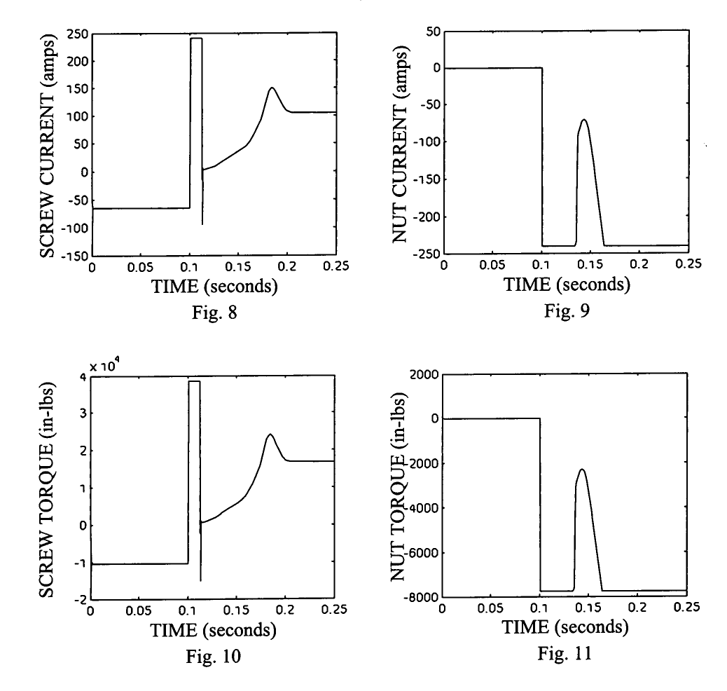

FIG. 8 shows the current supplied to the metering motor as a function of time.

FIG. 9 shows the current supplied to the injection motor as a function of time.

FIG. 10 shows the screw torque as a function of time, and FIG. 111 shows the nut torque as a function of time. It should be noted that the metering motor current and screw torque have similar profiles, and that the current supplied to the d.c. brushless motor and to the nut torque also have similar profiles, as would be expected.

Therefore, the present invention broadly provides an improved electro-mechanical injection actuator for controllably rotating and translating a feedscrew relative to a frame to express plastic material into a mold, which includes: a ball-screw mounted on the frame, the ball-screw having a nut matingly engaging a screw, the screw being attached to the feedscrew; an electric metering motor mounted on the frame and having a rotatable output shaft, the rotational movement of the output shaft being transmitted to the screw through a splined connection; an electric injection motor mounted on the frame and operatively arranged to selectively rotate the nut relative to said frame; and a ratchet-like unidirectional clutch or brake operatively arranged between the nut and frame for permitting the nut to rotate relative to the frame only in the angular direction needed to translate the feedscrew in a direction to express plastic material into the mold; whereby the clutch will prevent the nut from being moved in the opposite angular direction under the influence of the hot pressurized plastic material in the mold.

Modifications

The present invention expressly contemplates that many types of modifications and changes may be made.

For example, the speed reduction mechanism is optional, and may be changed or eliminated all together. In the preferred embodiment, the gear train 23 has a speed reduction ration of about 9:1, although this too may be changed.

The shape and configuration of the frame may also be changed. Motors other then d.c. brushless motors may be used as the injection motor, and these may be coupled directly or indirectly to the nut.

Therefore, while the presented-preferred form of the improved injection actuator has been shown and described, and still modifications thereof discussed, persons skilled in this art will readily appreciate that various additional changes and modifications may be made without departing from the spirit of the invention, as defined and differentiated by the following claims.

What is claimed is:

1. An actuator for holding a rotatable member against the reactionary force exerted by a compressed elastic load, comprising:
a frame;
a motor mounted on said frame and operatively arranged to selectively rotate said member in one angular direction relative to said frame to move a surface toward and away from said load; and
a unidirectional clutch acting between said member and frame for permitting said member to rotate in said one angular direction and for preventing said member from rotating in the opposite angular direction;
whereby said motor may be selectively operated to move said surface to engage said load, and said clutch will prevent said member from unintentionally rotating in said opposite direction under the influence of said load.

2. An actuator as set forth in claim 1 wherein said actuator includes a ball-screw having a screw and a nut, and wherein said rotatable member is said nut.

3. An actuator as set forth in claim 2 wherein said actuator is used to drive the feedscrew of a single-stage injection molding machine.

4. An actuator as set forth in claim 3 wherein said motor is an injection motor for translating said surface toward and away from said load.

5. An actuator as set forth in claim 4 wherein said motor is a brushless d.c. motor.

6. An actuator as set forth in claim 5 and further comprising a metering motor operatively arranged to selectively rotate the screw of said ball-screw relative to said frame.

7. An actuator as set forth in claim 6 and further comprising a gear train operatively arranged between said metering motor and said screw.

8. An actuator as set forth in claim 7 and further comprising a splined connection between said gear train and said screw.

9. An actuator for holding a rotatable member against the reactionary force exerted by a compressed elastic load, comprising:
a frame;
a motor mounted on said frame and operatively arranged to selectively rotate said member in one angular direction to move a surface toward and away from said load; and
a unidirectional brake acting between said member and frame for permitting said member to rotate in one angular direction and for preventing said member from rotating in the opposite angular direction relative to said frame;
whereby said motor may be selectively operated to move said surface to engage said load, and said clutch will prevent said member from unintentionally rotating in said opposite direction relative to said frame under the influence of said load.

10. An electromechanical injection actuator for controllably rotating and translating a feedscrew relative to a frame to express plastic material into a mold, comprising:
a ball-screw mounted on said frame, said ball-screw having a nut matingly engaging a screw, said screw being attached to said feedscrew;
an electric metering motor mounted on said frame and having a rotatable output shaft, the rotational movement of said output shaft being transmitted to said screw through a splined connection;
an electric injection motor mounted on said frame and operatively arranged to selectively rotate said nut relative to said frame; and
a unidirectional clutch operatively arranged between said nut and frame for permitting said nut to rotate relative to said frame only in the angular direction needed to translate said feedscrew in a direction to express plastic material into said mold;
whereby said clutch will prevent said nut from being moved in the opposite angular direction under the influence of the pressurized plastic material in said mold.

11. An electromechanical injection actuator as set forth in claim 10 wherein said injection motor is a d.c. brushless motor.

12. An electromechanical injection actuator as set forth in claim 11 and further comprising a speed reducer between said output shaft and said screw.

13. An electromechanical injection actuator as set forth in claim 12 wherein said speed reducer is a gear train.

14. An electromechanical injection actuator as set forth in claim 13 wherein said gear train has a speed reduction ratio of about 9:1.

15. An electromechanical injection actuator for controllably rotating and translating a feedscrew relative to a frame to express plastic material into a mold, comprising:
a ball-screw mounted on said frame, said ball-screw having a nut matingly engaging a screw, said screw being attached to said feedscrew;
an electric metering motor mounted on said frame and having a rotatable output shaft, the rotational movement of said output shaft being transmitted to said screw through a splined connection;
an electric injection motor mounted on said frame and operatively arranged to selectively rotate said nut relative to said frame; and
a unidirectional brake operatively arranged between said nut and frame for permitting said nut to rotate relative to said frame only in the angular direction needed to translate said feedscrew in a direction to express plastic material into said mold;
whereby said clutch will prevent said nut from being moved in the opposite angular direction under the influence of the pressurized plastic material in said mold.

16. An electromechanical injection actuator as set forth in claim 15 wherein said injection motor is a d.c. brushless motor.

17. An electro-mechanical injection actuator as set forth in claim 16 and further comprising a speed reducer between said output shaft and said screw.

18. An electromechanical injection actuator as set forth in claim 17 wherein said speed reducer is a gear train.

19. An electromechanical injection actuator as set forth in claim 18 wherein said gear train has a speed reduction ratio of about 9:1.
